(19) United States
(12) Patent Application Publication
(10) Pub. No.: US 2016/0276749 A1
(43) Pub. Date: Sep. 22, 2016

(54) BENT-SHAPED ANTENNA DEVICE

(71) Applicant: TDK Corporation, Tokyo (JP)

(72) Inventors: Toshifumi KOMACHI, Tokyo (JP); Hirohumi Asou, Tokyo (JP); Toshio Tomonari, Tokyo (JP)

(73) Assignee: TDK Corporation, Tokyo (JP)

(21) Appl. No.: 15/068,866

(22) Filed: Mar. 14, 2016

(30) Foreign Application Priority Data
Mar. 19, 2015 (JP) 2015-056629

(51) Int. Cl. H01Q 9/04; H01Q 1/24; H01Q 1/36

(52) U.S. Cl. CPC H01Q 9/0414; H01Q 1/36; H01Q 1/243

(57) ABSTRACT

An antenna device is provided with a planar coil antenna having a planar section provided along a first plane and a first folded section provided along a second plane crossing the first plane and a first metal layer. A first border line between the planar section and the first folded section crosses an inner diameter portion of the planar coil antenna. The first metal layer covers at least a part of the planar section of the planar coil antenna and at least a part of the inner diameter portion.

### BACKGROUND OF THE INVENTION

1. Field of the Invention

The present invention relates to an antenna device and, more particularly, to an antenna device suitable for NFC (Near Field Communication).

2. Description of Related Art

In recent years, a mobile electronic device such as a smartphone is equipped with an RFID (Radio Frequency Identification: individual identification by radio waves) system and further equipped with, as a communication means of the RFID, an antenna for performing near field communication with a reader/writer and the like.

Further, the mobile electronic device is provided with a metallic shield so as to protect a built-in circuit from external noise and to prevent unnecessary radiation of noise generated inside the device. Particularly, recently, a housing itself of the mobile electronic device is made of metal instead of resin, considering thinness, light weight, durability against drop impact, design, and the like. Cases where the metallic housing doubles as the metallic shield have been increasing. However, since generally the metallic shield shields electric waves, when an antenna needs to be provided, it is necessary to arrange the antenna at a position not overlapping the metallic shield. When the metallic shield is arranged over a wide range, arrangement of the antenna becomes a serious problem.

To solve the above problem, in antenna devices disclosed in, e.g., Japanese Patent No. 4,687,832, Japanese Patent Application Laid-Open No. 2002-111363, and Japanese Patent Application Laid-Open No. 2013-162195, an opening is formed in a metal layer, a slit connecting the opening and an outer edge is formed, and an antenna coil is arranged such that an opening of the antenna coil overlaps with the opening of the metal layer. In this configuration, current flows in the metal layer so as to shield a magnetic field generated by flowing of current in a coil conductor, and the current flowing around the opening of the metal layer passes around the slit, with the result that current flows also around the metal layer by edge effect. As a result, a magnetic field is generated also from the metal layer, and the metal layer makes a large loop of a magnetic flux, thereby increasing a communication distance between the antenna device and an antenna of an apparatus at a communication partner side. That is, it is possible to allow the metal layer to function as an accelerator for increasing a communication distance of the antenna coil.

However, in the above conventional antenna device, it is necessary to form the opening and the slit in the metal layer, which imposes restrictions on freedom of layout of the antenna coil. For example, when the opening cannot be formed at a desired position due to design restrictions, or when formation of the slit is not allowed even though the opening can be formed, the antenna device cannot be constructed. The same problem occurs when an opening for exposing a lens of a camera module cannot be used as the opening for the antenna coil.

### SUMMARY

An object of the present invention is therefore to provide an antenna device capable of increasing a communication distance and widening directivity even when the opening or the slit is not formed in the metal layer provided on a mobile electronic apparatus side.

To solve the above problems, an antenna device according to the present invention includes a planar coil antenna having a planar section provided along a first plane and a first folded section provided along a second plane crossing the first plane and a first metal layer, wherein a first border line between the planar section and the first folded section crosses an inner diameter portion of the planar coil antenna, and the first metal layer covers at least a part of the planar section of the planar coil antenna and at least a part of the inner diameter portion.

According to the present invention, communication can be performed even when an opening or a slit is not formed in the first metal layer that covers the planar coil antenna, allowing the first metal layer to function as an accelerator, whereby a communication distance of the antenna device can be increased. Further, providing the first folded section allows the antenna directivity to be widened.

In the present invention, the planar coil antenna is preferably formed on a flexible substrate and folded together with the flexible substrate. With this configuration, a folded structure of the planar coil antenna can be easily achieved, allowing a degree of freedom of mounting to be increased.

The antenna device of the present invention preferably further includes a second metal layer that covers at least a part of the first folded section of the planar coil antenna and at least another part of the inner diameter portion, wherein a first slit region interposed between the first and second metal layers is overlapped with the inner diameter portion of the planar coil antenna. With this configuration, an electromagnetic wave from the planar coil antenna can be radiated through the first slit region, allowing the first and second metal layers to function as an accelerator, whereby a communication distance of the antenna device can be increased.

The antenna device according to the present invention preferably further includes a first connecting portion that connects a part of the first metal layer and a part of the second metal layer across the first slit region. With this configuration, the first and second metal layers can be handled as one metal body and can thus be produced by one mold. Thus, a relative arrangement variation among the first and second metal layers and a variation in a width of the first slit region can be prevented.

In the present invention, the first and second metal layers preferably constitute a part of a casing of a mobile electronic device that houses the planar coil antenna. In this case, it is more preferable that the casing has a main surface extending along the first plane and a first side surface extending along the second plane, the first metal layer is formed on the main surface, and the second metal layer is formed on the first side surface. With this configuration, the planar coil antenna folded along a corner section of the casing can be disposed inside the casing, whereby a communication distance of the antenna can be increased, and directivity thereof can be widened.

In the present invention, the first metal layer may be formed on the entire area of the main surface and cover the entire area of the planar section of the planer coil antenna. Alternatively, the second metal layer may be formed on the entire area of the first side surface and cover the entire area of the first folded section of the planer coil antenna. In either case, an electromagnetic wave from the planar coil antenna can be radiated through the slit region interposed between the two metal layers, allowing the metal layers to function as an accelerator.

In the present invention, it is preferable that the planar coil antenna further includes a second folded section provided along a third plane crossing the first plane, and a second border line between the planar section and the second folded section crosses the inner diameter portion. With this configuration, it is possible to form a larger sized planar coil antenna by effectively utilizing a limited space. Thus, it is possible to realize wider antenna directivity and longer communication distance.

It is preferable that the antenna device according to the present invention further includes a third metal layer that covers at least a part of the second folded section of the planar coil antenna and at least another part of the inner diameter portion, wherein a second slit region interposed between the first and third metal layers is overlapped with the inner diameter portion. With this configuration, an electromagnetic wave from the planar coil antenna can be radiated through each of the first and second slits, allowing the first to third metal layers to function as an accelerator, whereby a communication distance of the antenna device can further be increased.

The antenna device according to the present invention preferably further includes a second connecting portion that connects a part of the first metal layer and a part of the third metal layer across the second slit region. With this configuration, the first to third metal layers can be handled as one metal body and can thus be produced by one mold. Thus, an arrangement variation among the first to third metal layers can be prevented, and a variation between the widths of the first and second slit regions can be prevented.

In the present invention, the first to third metal layers preferably constitute apart of a casing of a mobile electronic device that houses the planar coil antenna. In this case, it is more preferable that the casing has a main surface extending along the first plane, a first side surface extending along the second plane and a second side surface extending along the third plane, the first metal layer is formed on the main surface, the second metal layer is formed on the first side surface, and the third metal layer is formed on the second side surface. With this configuration, the planar coil antenna folded along two corner sections of the casing can be disposed inside the casing, whereby a communication distance of the antenna can further be increased, and the directivity thereof can further be widened.

In the present invention, the first metal layer may be formed on the entire area of the main surface and cover the entire area of the planar section of the planer coil antenna. Alternatively, the second metal layer may be formed on the entire area of the first side surface and cover the entire area of the first folded section of the planer coil antenna. Further alternatively, the third metal layer may be formed on the entire area of the second side surface and cover the entire area of the second folded section of the planer coil antenna. In either case, an electromagnetic wave from the planar coil antenna can be radiated through the slit region interposed between the two metal layers, allowing the metal layers to function as an accelerator.

According to the present invention, it is possible to provide an antenna device capable of increasing a communication distance and widening directivity even when an opening or a slit is not formed in the metal layer provided on a mobile electronic apparatus side.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic perspective view transparently illustrating a configuration of an antenna device according to a first embodiment of the present invention;

FIG. 2 is a schematic cross-sectional view of the antenna device of FIG. 1 taken along a line Y₁-Y₁;

FIG. 3 is a plan view explaining an action of the first and second metal layers 21 and 22 on the planar coil antenna 10;

FIG. 4 is a schematic cross-sectional view explaining an action of the first and second metal layers 21 and 22 on the planar coil antenna 10;

FIG. 5 is a schematic perspective view transparently illustrating a configuration of an antenna device according to a second embodiment of the present invention;

FIG. 6 is a schematic cross-sectional view of the antenna device of FIG. 5;

FIG. 7 is a schematic perspective view transparently illustrating a configuration of an antenna device according to a third embodiment of the present invention;

FIG. 8 is a schematic perspective view transparently illustrating a configuration of an antenna device according to a fourth embodiment of the present invention; and

FIGS. 9A and 9B are schematic perspective views each illustrating configurations of the first and second metal layers 21 and 22, which are modification of the first embodiment.

### DETAILED DESCRIPTION OF THE EMBODIMENTS

Preferred embodiments of the present invention will be explained below in detail with reference to the accompanying drawings.

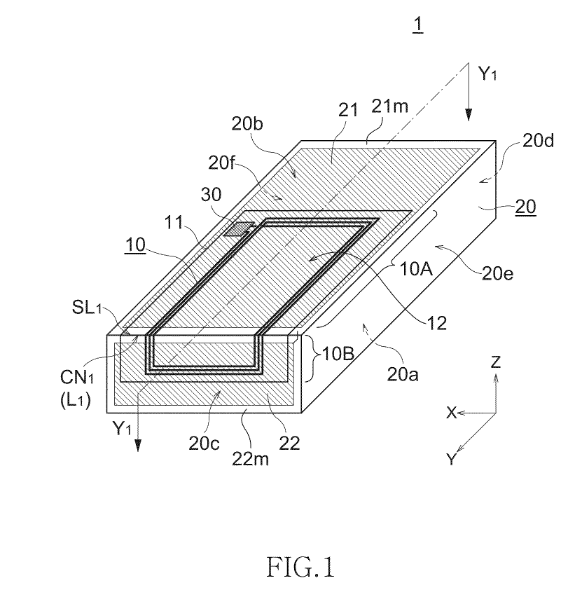

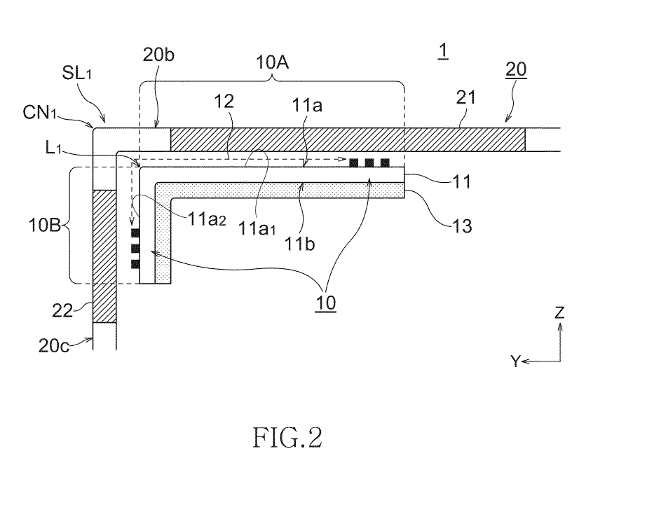

FIG. 1 is a schematic perspective view transparently illustrating a configuration of an antenna device according to a first embodiment of the present invention. FIG. 2 is a schematic cross-sectional view of the antenna device of FIG. 1 taken along a line Y₁-Y₁.

As illustrated in FIGS. 1 and 2, an antenna device 1 includes a planar coil antenna 10 and a casing 20 that houses the planar coil antenna 10. The casing 20 is a casing for a mobile electronic device such as a smartphone and has a substantially thin rectangular parallelepiped shape. Thus, the casing 20 has front and back surfaces 20a and 20b parallel to an XY plane, first and second side surfaces 20c and 20d perpendicular to a Y-direction which is a longitudinal direction of the front and back surfaces 20a and 20b, and third and fourth side surfaces 20e and 20f parallel to the Y-direction. The first side surface 20c is parallel to an XZ plane. In the illustrated antenna device 1, the back surface 20b faces upward, and a touch panel display and the like is provided on the front surface 20a which is one main surface of the casing 20. The planar coil antenna 10 is provided mainly on the back surface 20b which is the other main surface of the casing 20.

As illustrated in FIG. 2, the planar coil antenna 10 is constituted of a spiral pattern formed on one main surface 11a of a flexible substrate (flexible printed board) 11. On the other main surface 11b of the flexible substrate 11, a magnetic sheet 13 is provided. The flexible substrate 11 is made of, e.g., a PET resin. A planar size of the flexible substrate 11 is appropriately set in accordance with a size of the spiral pattern and is set to, e.g., 40 mm×50 mm. A thickness of the flexible substrate 11 is, e.g., 30 μm.

The flexible substrate 11 is provided inside the casing 20 such that the one main surface 11a thereof faces an outside of the casing 20. Accordingly, in the casing 20, the planar coil antenna 10 is disposed outside of the magnetic sheet 13. The planar coil antenna 10 is preferably formed into a rectangular spiral pattern so as to facilitate antenna design and to increase an opening area as much as possible. Both ends of the spiral pattern are connected to, e.g., an NFC chip 30. The both ends of the spiral pattern may be connected to a main circuit board (not illustrated) of a mobile electronic device provided in the casing 20.

The planar coil antenna 10 has a structure in which it is folded, together with the flexible substrate 11, along a corner section CN₁ at which the back surface 20b of the casing 20 and the first side surface 20c cross each other. Accordingly, the one main surface 11a of the flexible substrate 11 has a first plane 11a₁ parallel to the XY plane and a second plane 11a₂ parallel to the XZ plane, and the planar coil antenna 10 has a planar section 10A provided along the first plane 11a₁ and a first folded section 10B provided along the second plane 11a₂, the first folded section 10B being obtained by folding the planar coil antenna 10 at the first corner section CN₁. A border line (first folding line) L₁ between the planar section 10A and the first folded section 10B crosses an inner diameter portion 12 surrounded by the planar coil antenna 10.

In the casing 20, the magnetic sheet 13 is disposed at an inside of the planar coil antenna 10. The planar coil antenna 10 is often mounted in proximity to a battery pack of the mobile electronic device; however, when the magnetic sheet 13 is interposed between the battery pack and planar coil antenna 10, it is possible to ensure a magnetic path for flux generated by current flowing in the planar coil antenna 10. This can reduce influence that a metal body constituting the battery pack has on the planar coil antenna 10, whereby desired antenna characteristics can be obtained.

The magnetic sheet 13 is preferably a composite magnetic sheet obtained by coupling flat-shaped magnetic metal particles having a large aspect ratio with a polymer. The flat-shaped metal particles are overlapped in a thickness direction of the composite magnetic sheet, and a surface direction thereof is oriented parallel to a surface direction of the composite magnetic sheet, so that an effective magnetic permeability of the composite magnetic sheet in the surface direction can be increased. This allows a magnetic field generated by the planar coil antenna 10 to be drawn into the magnetic sheet 13 from outside and guided in a horizontal direction perpendicular to a coil axis. While the flat-shaped magnetic particles are arranged densely in the polymer, they are isolated from one another by the polymer, whereby generation of an eddy current can be prevented. Thus, it is possible to realize both high magnetic permeability and low magnetic loss in a high frequency band of an RFID.

First and second metal layers 21 and 22 are formed on the back surface 20b and the first side surface 20c of the casing 20, respectively, so as to cover an outside of the planar coil antenna 10. In the present embodiment, the first and second metal layers 21 and 22 are each a thick metal plate that itself serves as a wall material; however, they may each be a thin metal foil formed on a surface of a resin wall material.

The first metal layer 21 covers substantially the entire surface of the back surface 20b of the casing 20; however, a peripheral edge of the back surface 20b is a margin region 21m with a certain width in which the metal layer is absent. Similarly, the second metal layer 22 covers substantially the entire surface of the first side surface 20c of the casing 20; however, a peripheral edge of the first side surface 20c is a margin region 22m with a certain width in which the metal layer is absent. A wall material of each of the margin regions 21m and 22m is preferably a resin. With the above configuration, the first corner section CN₁ at which the back surface 20b and the first side surface 20c of the casing 20 cross each other is interposed between the first and second metal layers 21 and 22 and constitutes a first slit region SL₁ not covered by the metal layer.

The first metal layer 21 covers a part of the planar section 10A of the planar coil antenna 10 and a part of the inner diameter portion 12. The second metal layer 22 covers a part of the first folded section 10B and a part of the inner diameter portion 12. The first metal layer 21 has an area larger than that of the second metal layer 22 and, accordingly, the planar coil antenna 10 is covered more widely by the first metal layer 21 than by the second metal layer 22.

The first slit region SL₁ interposed between the first and second metal layers 21 and 22 is formed parallel to a ridge line of the first corner section CN₁ and is overlapped with the inner diameter portion 12 of the planar coil antenna 10. Thus, an electromagnetic wave generated from the planar coil antenna 10 can be radiated outside the first and second metal layers 21 and 22 from the first slit region SL₁.

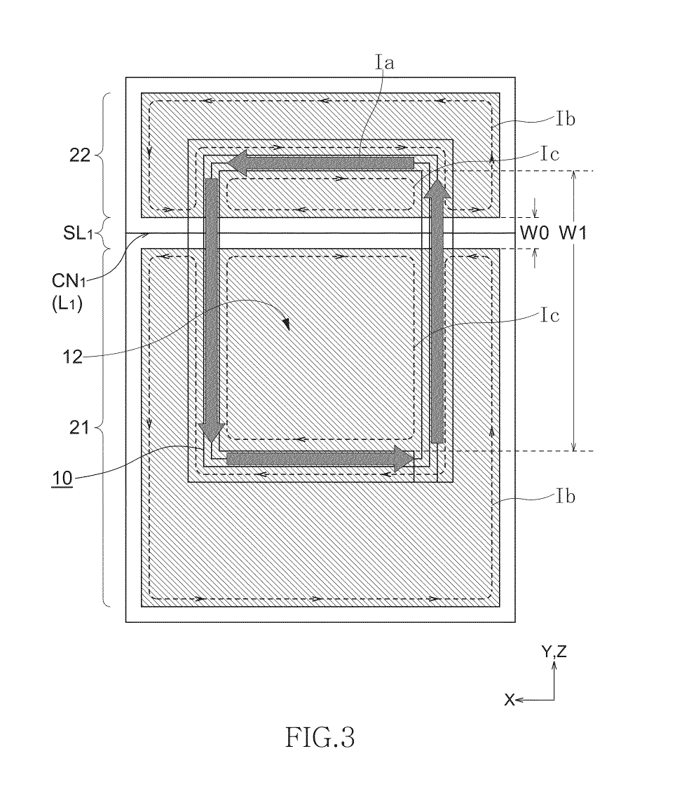

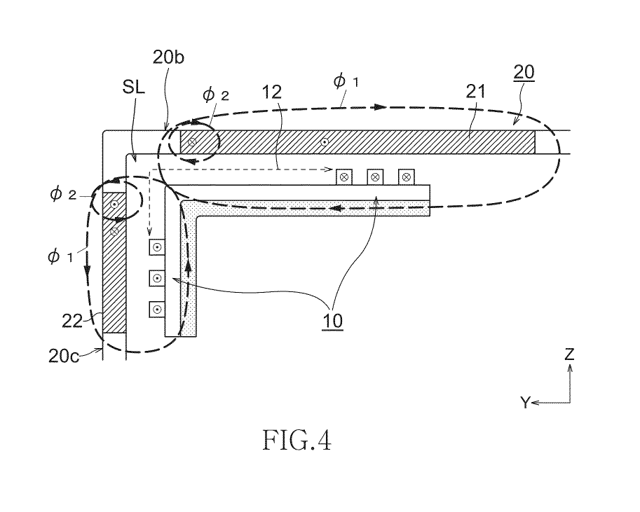

FIGS. 3 and 4 are views each explaining an action of the first and second metal layers 21 and 22 on the planar coil antenna 10. FIG. 3 is a plan view in which the planar coil antenna 10 and the second metal layer 22 are seen in an unfolded manner such that the first side surface 20c is in the same plane as the back surface 20b. FIG. 4 is a schematic cross-sectional view taken along the line Y₁-Y₁.

As illustrated in FIG. 3, a width W₀ of the first slit region SL₁ is smaller than a width W₁ of the inner diameter portion 12 of the planar coil antenna 10 in the same direction (Y- and Z-directions). Thus, the first and second metal layers 21 and 22 each have a region overlapped with the inner diameter portion 12 in a plan view. When a counterclockwise current Ia flows in the planar coil antenna 10, a magnetic flux penetrating the inner diameter portion 12 of the planar coil antenna 10 is generated. This magnetic flux passes through the first slit region SL₁ interposed between the first and second metal layers 21 and 22 and circulates around each of the first and second metal layers 21 and 22. On the other hand, a current in a direction canceling the magnetic flux flows in the first and second metal layers 21 and 22. This current becomes eddy currents Ib and Ic generated outside and inside the planar coil antenna 10, respectively, by an edge effect.

Further, as illustrated in FIG. 4, the current Ia flowing in the planar coil antenna 10 generates magnetic fluxes φ₁ and φ₂ interlinked with the planar coil antenna 10. The magnetic flux φ₁ is a magnetic flux loop that passes through the first slit region SL₁ and circulates widely outside the first and second metal layers 21 and 22. The magnetic flux φ₂ is a magnetic flux loop that is generated by the eddy current Ic generated in a region overlapped with the inner diameter portion 12 and works to boost the magnetic flux φ₁.

The magnetic flux φ₁ that has passed through the first slit region SL₁ interposed between the first and second metal layers 21 and 22 attempts to widely circulate around each of the first and second metal layers 21 and 22 by advancing along a path starting from the first slit region SL₁ toward an outer edge of each of the metal layers 21 and 22. As a result, the magnetic flux φ₁ draws a large loop to be magnetically coupled with an antenna coil of a reader/writer. Particularly, since a planar size of the entire metal layer including the first and second metal layers 21 and 22 is larger than a planar size of the planar coil antenna 10, a larger loop magnetic field can be generated.

As described above, in the antenna device 1 according to the present embodiment, the first slit region SL₁ interposed between the first and second metal layers 21 and 22 is formed at the corner section CN₁ of the casing 20, and the inner diameter portion 12 of the planar coil antenna 10 is overlapped with the first slit region SL₁. Thus, even in a case where substantially the entire surface of the back surface 20b of the casing 20 is covered by the first metal layer 21 and where the first metal layer 21 is not provided with a slit or an opening, an electromagnetic wave from the planar coil antenna 10 can be radiated outside the first and second metal layers 21 and 22, allowing the antenna device 1 to communicate with the reader/writer. Further, the first and second metal layers 21 and 22 make the magnetic flux loop of the planar coil antenna 10 widely circulate, whereby a communication distance of the antenna device 1 can be increased. Further, the planar coil antenna 10 is folded along the corner section CN₁ of the casing 20, so that the antenna directivity can be widened.

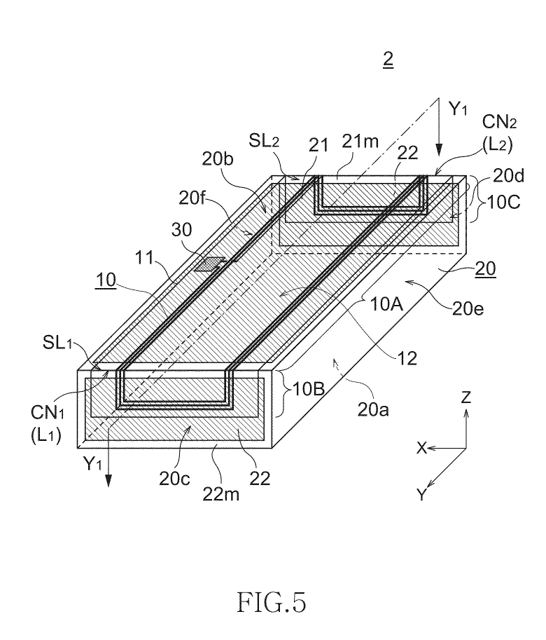

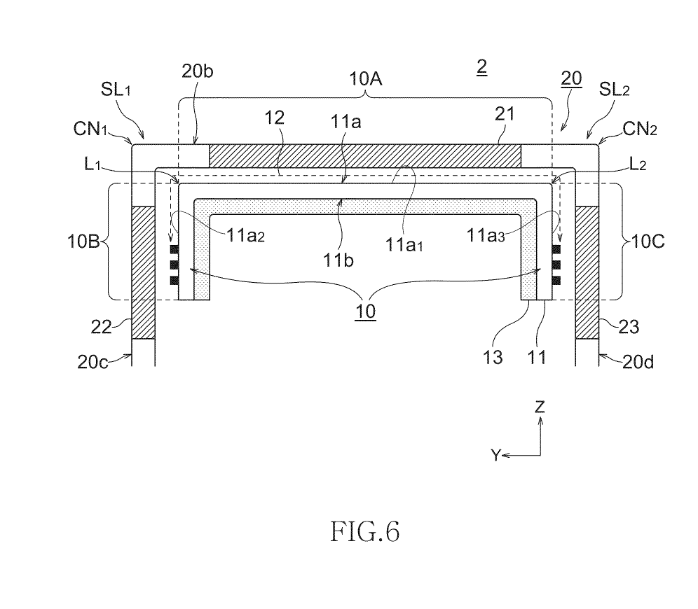

FIG. 5 is a schematic perspective view transparently illustrating a configuration of an antenna device according to a second embodiment of the present invention. FIG. 6 is a schematic cross-sectional view of the antenna device of FIG. 5.

As illustrated in FIGS. 5 and 6, an antenna device 2 of the present embodiment is featured in that a width of the planar coil antenna 10 in a longitudinal direction (Y-direction) is larger than a width of the back surface 20b of the casing 20 in a longitudinal direction (Y-direction) and, thus, the planar coil antenna 10 has a structure in which it is folded twice, together with the flexible substrate 11, along two corner sections. That is, the planar coil antenna 10 is folded along the first corner section CN₁ formed by the back surface 20b of the casing 20 and the first side surface 20c and further folded along a second corner section CN₂ formed by the back surface 20b of the casing 20 and the second side surface 20d.

As illustrated in FIG. 6, one main surface 11a of the flexible substrate 11 has a first plane 11a₁ parallel to the XY plane and the second and third planes 11a₂ and 11a₃ parallel to the XZ plane, and the planar coil antenna 10 has a planar section 10A provided along the first plane 11a₁, a first folded section 10B provided along the second plane 11a₂, and a second folded section 10C provided along the third plane 11a₃. A border line (second folding line) L₂ between the planar section 10A and the second folded section 10C crosses an inner diameter portion 12 surrounded by the planar coil antenna 10.

A third metal layer 23 is formed on the second side surface 20d of the casing 20 so as to cover an outside of the planar coil antenna 10 together with the first and second metal layers 21 and 22. In particular, the third metal layer 23 covers a part of the planar section 10C of the planar coil antenna 10 and a part of the inner diameter portion 12 that constitute the second folded section 10C of the planar coil antenna 10.

The corner section CN₂ at which the back surface 20b of the casing 20 and the second side surface 20d cross each other is interposed between the first metal layer 21 and the third metal layer 23 and constitutes a second slit region SL₂ not covered by the metal layer. The second slit region SL₂ is formed parallel to a ridge line of the second corner section CN₂ and is overlapped with the inner diameter portion 12 of the planar coil antenna 10. Other configurations are the same as those of the first embodiment.

The first embodiment has a single slit structure, while the second embodiment has a double-slit structure. An electromagnetic wave generated from the planar coil antenna 10 is radiated outside the first to third metal layers 21 to 23 from each of the first and second slit regions SL₁ and SL₂.

According to the present embodiment, in addition to the effects obtained by the first embodiment, an antenna's radiation efficiency can be increased. Further, it is possible to form a larger sized planar coil antenna 10 by effectively utilizing a limited space in the casing 20. Thus, it is possible to realize wider antenna directivity and longer communication distance than in the antenna device of the first embodiment.

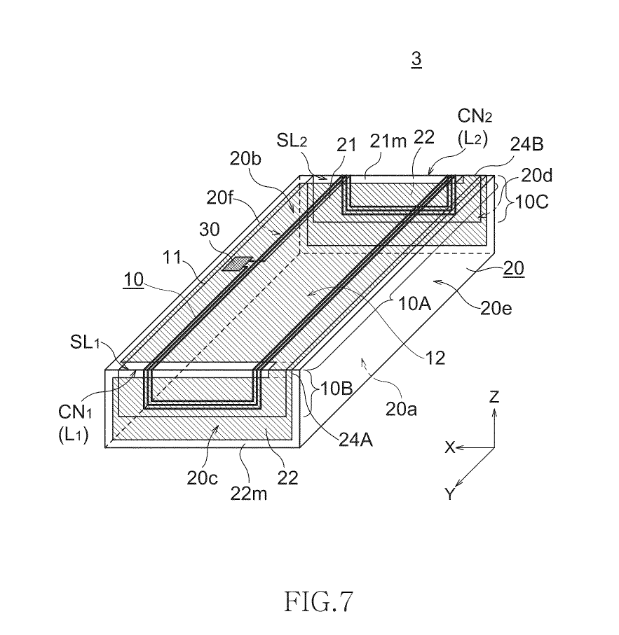

FIG. 7 is a schematic perspective view transparently illustrating a configuration of an antenna device according to a third embodiment of the present invention.

As illustrated in FIG. 7, an antenna device 3 of the present embodiment is a modification of the second embodiment and is featured in that the first to third metal layers 21 to 23 are connected through connecting portions 24A and 24B to be integrated with one another. Other configurations are the same as those of the second embodiment. While the present embodiment is a modification of the second embodiment, it may be made to be a modification of the first embodiment. In this case, the second connecting portion 24B is omitted.

The first connecting portion 24A serves to prevent the first and second metal layers 21 and 22 from being completely separated from each other by the first slit region SL₁ extending in the X-direction and connects a part of the first metal layer 21 and a part of the second metal layer 22 across the first slit region SL₁. The first connecting portion 24A is provided so as to close one end portion of the first slit region SL₁. That is, a width of the first slit region SL₁ is constant over the entire length thereof. A width of the first connecting portion 24A in the longitudinal direction (X-direction) of the first slit region SL₁ is preferably equal to or less than 1/3 and more preferably 1/5 of a width of each of the first and second metal layers 21 and 22 in the same direction.

Similarly, the second connecting portion 24B serves to prevent the first and third metal layers 21 and 23 from being completely separated from each other by the second slit region SL₂ extending in the X-direction and connects a part of the first metal layer 21 and a part of the third metal layer 23 across the second slit region SL₂.

While the first and second metal layers 21 and 22 are separated, in large part, from each other by the first slit region SL₁, they are connected partially to each other by the first connecting portion 24A. That is, the first and second metal layers 21 and 22 are not completely separated from each other both physically and electrically. Similarly, while the first and third metal layers 21 and 23 are separated, in large part, from each other by the second slit region SL₂, they are connected partially to each other by the second connecting portion 24B. That is, the first and third metal layers 21 and 23 are not completely separated from each other both physically and electrically. Thus, the first to third metal layers 21 to 23 can be handled as one metal body and can thus be produced by one mold. Further, since the first to third metal layers 21 to 23 are integrated with one another, a relative arrangement variation among them can be prevented, and a variation between the widths of the first and second slit regions SL₁ and SL₂ can be prevented.

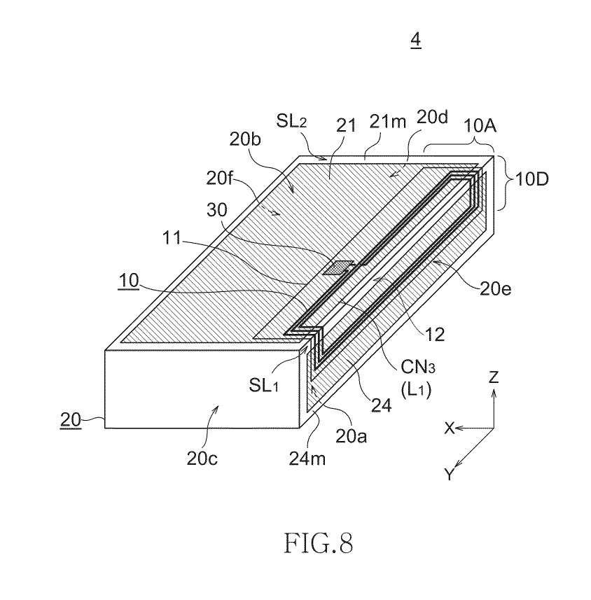

FIG. 8 is a schematic perspective view transparently illustrating a configuration of an antenna device according to a fourth embodiment of the present invention.

As illustrated in FIG. 8, an antenna device 4 of the present embodiment is featured in that the planar coil antenna 10 is folded along a third corner section CN₃ parallel to a longitudinal direction (Y-direction) of the casing 20. Thus, the planar coil antenna 10 has a planar section 10A parallel to the back surface 20b of the casing 20 and a first folded section 10D parallel to the third side surface 20e, the first folded section 10D being obtained by folding the planar coil antenna 10 at the third corner section CN₃. A folding line (first folding line) formed at a position at which the planar section 10A and the first folded section 10D cross each other crosses the inner diameter portion 12 surrounded by the planar coil antenna 10. The planar coil antenna 10 preferably has an outer shape in which a width thereof in the Y-direction is larger than widths thereof in the X- and Z-directions (that is, the planar coil antenna 10 is preferably elongated in the Y-direction).

A second metal layer 24 is provided on the third side surface 20e of the casing 20. The second metal layer 24 covers a part of the planar coil antenna 10 and a part of the inner diameter portion 12 that constitute the first folded section 10D of the planar coil antenna 10. The third corner section CN₃ at which the back surface 20b of the casing 20 and the third side surface 20e cross each other is interposed between the first metal layer 21 and the second metal layer 24 and constitutes a first slit region SL₁ not covered by the metal layer. The first slit region SL₁ is formed parallel to a ridge line of the third corner section CN₃ and is overlapped with the inner diameter portion 12 of the planar coil antenna 10. Other configurations are the same as those of the first embodiment.

According to the present embodiment, in addition to the effects obtained by the first embodiment, the first slit region SL₁ can be increased in length to increase a range where the inner diameter portion 12 of the planar coil antenna 10 is overlapped with the slit region, whereby an antenna's radiation efficiency can be increased.

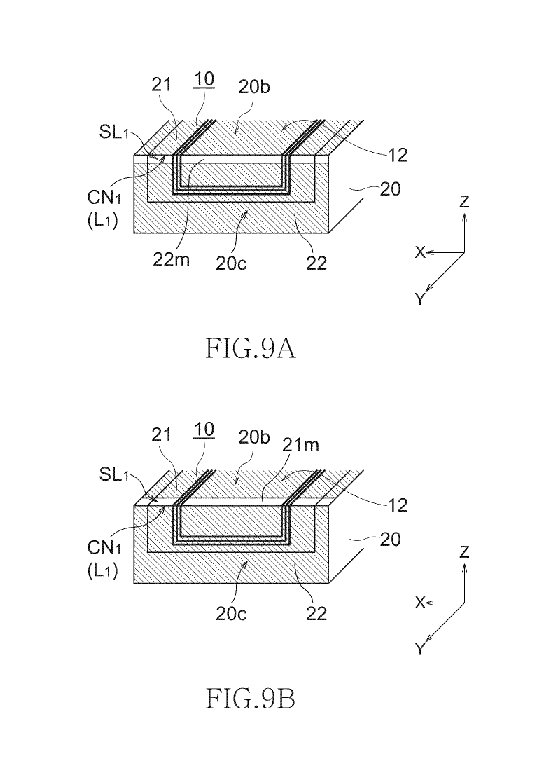

FIGS. 9A and 9B are schematic perspective views each illustrating configurations of the first and second metal layers 21 and 22, which are modification of the first embodiment.

In the above first to fourth embodiments, the first metal layer 21 is not formed on the entire area of the back surface 20b of the casing 20, and the margin region 21m is formed over the entire peripheral edge of the back surface 20b. Further, the second metal layer 22 is not formed on the entire area of the first side surface 20c of the casing 20, and the margin region 22m is formed over the entire peripheral edge of the first side surface 20c. However, shapes of the first and second metal layers 21 and 22 are not especially limited as long as the slit region is formed between the first and second metal layers 21 and 22.

For example, a configuration as illustrated in FIG. 9A may be possible. That is, the first metal layer 21 is formed on the entire area of the back surface 20b of the casing 20; and the second metal layer 22 is not formed on the entire area of the first side surface 20c, and the margin region 22m is provided only on one side of the first side surface 20c that includes the ridge line of the corner section CN₁. In this case, the first metal layer 21 covers the entire spiral pattern and entire inner diameter portion 12 that constitute the planar section 10A of the planar coil antenna 10.

Further, a configuration as illustrated in FIG. 9B may also be possible. That is, contrary to the configuration illustrated in FIG. 9A, the second metal layer 22 is formed on the entire area of the first side surface 20c; and the first metal layer 21 is not formed on the entire area of the back surface 20b, and the margin region 21m is provided only on one side of the back surface 20b that includes the ridge line of the corner section CN₁. In this case, the second metal layer 22 covers the entire spiral pattern and entire inner diameter portion 12 that constitute the first folded section 10B of the planar coil antenna 10.

Depending on design of the mobile electronic device, it is possible to form the entire area of the back surface 20b of the casing 20 as the metal surface or form the entire area of the first or second side surface 20c or 20d as the metal surface. Even in such a configuration, it is possible to form, between the first and second metal layers 21 and 22, a slit region where the metal layer is absent, allowing the first and second metal layers 21 and 22 to function as an accelerator. The present embodiment is applicable to the second to fourth embodiments.

It is apparent that the present invention is not limited to the above embodiments, but may be modified and changed without departing from the scope and spirit of the invention.

For example, although the first folded section 10B is provided corresponding to the first side surface of the casing in the first embodiment, it may be provided corresponding to any of the second to fourth side surface. Further, although the first and second folded sections 10B and 10C are provided corresponding to the first and second side surfaces of the casing, respectively in the second embodiment, they may be provided corresponding to the third and fourth side surfaces, respectively, or to any one of the first and second side surfaces and any one of the third and fourth side surfaces. Further, the folded section may be provided corresponding to the all (first to fourth) side surfaces.

Further, the second metal layer 22 is provided on the first side surface 20c of the casing 20 in the first embodiment, and the second and third metal layers 22 and 23 are provided on the first and second side surfaces 20c and 20d, respectively, in the second embodiment. However, the second metal layer 22 and the third metal layer 23 are not essential but may be omitted. That is, it is only necessary to provide at least the first metal layer 21 on the back surface 20b (main surface) of the casing 20.

Further, although the planar coil antenna 10 is constituted by a spiral pattern with several turns in the above respective embodiments, the loop pattern may be one in which the number of turns is less than one. That is, the planar antenna coil 10 only needs to be a loop-shaped or a spiral-shaped planar coil pattern. In a case of the loop pattern in which the number of turns is less than one, the number of turns is preferably 3/4 or more, and an inside of a circle defined by a diameter of the loop can be regarded as the inner diameter portion 12 of the planar coil antenna 10.

What is claimed is:

1. An antenna device comprising:
a planar coil antenna having a planar section provided along a first plane and a first folded section provided along a second plane crossing the first plane; and
a first metal layer, wherein
a first border line between the planar section and the first folded section crosses an inner diameter portion of the planar coil antenna, and
the first metal layer covers at least apart of the planar section of the planar coil antenna and at least a part of the inner diameter portion.

2. The antenna device as claimed in claim 1, wherein the planar coil antenna is formed on a flexible substrate and folded together with the flexible substrate.

3. The antenna device as claimed in claim 1 further comprising a second metal layer that covers at least a part of the first folded section of the planar coil antenna and at least another part of the inner diameter portion,
wherein a first slit region interposed between the first and second metal layers is overlapped with the inner diameter portion of the planar coil antenna.

4. The antenna device as claimed in claim 3 further comprising a first connecting portion that connects a part of the first metal layer and a part of the second metal layer across the first slit region.

5. The antenna device as claimed in claim 3, wherein the first and second metal layers constitute a part of a casing of a mobile electronic device that houses the planar coil antenna.

6. The antenna device as claimed in claim 5, wherein
the casing has a main surface extending along the first plane and a first side surface extending along the second plane,
the first metal layer is formed on the main surface, and
the second metal layer is formed on the first side surface.

7. The antenna device as claimed in claim 6, wherein the first metal layer is formed on a substantially entire area of the main surface and covers a substantially entire area of the planar section of the planer coil antenna.

8. The antenna device as claimed in claim 6, wherein the second metal layer is formed on a substantially entire area of the first side surface and covers a substantially entire area of the first folded section of the planer coil antenna.

9. The antenna device as claimed in claim 1, wherein
the planar coil antenna further includes a second folded section provided along a third plane crossing the first plane, and
a second border line between the planar section and the second folded section crosses the inner diameter portion.

10. The antenna device as claimed in claim 9 further comprising a third metal layer that covers at least a part of the second folded section of the planar coil antenna and at least another part of the inner diameter portion,
wherein a second slit region interposed between the first and third metal layers is overlapped with the inner diameter portion.

11. The antenna device as claimed in claim 10 further comprising a second connecting portion that connects a part of the first metal layer and a part of the third metal layer across the second slit region.

12. The antenna device as claimed in claim 10, wherein the first to third metal layers constitute a part of a casing of a mobile electronic device that houses the planar coil antenna.

13. The antenna device as claimed in claim 12, wherein
the casing has a main surface extending along the first plane, a first side surface extending along the second plane and a second side surface extending along the third plane,
the first metal layer is formed on the main surface,
the second metal layer is formed on the first side surface, and
the third metal layer is formed on the second side surface.

14. The antenna device as claimed in claim 13, wherein the first metal layer is formed on a substantially entire area of the main surface and covers a substantially entire area of the planar section of the planer coil antenna.

15. The antenna device as claimed in claim 13, wherein the second metal layer is formed on a substantially entire area of the first side surface and covers a substantially entire area of the first folded section of the planer coil antenna.

16. The antenna device as claimed in claim 13, wherein the third metal layer is formed on a substantially entire area of the second side surface and covers a substantially entire area of the second folded section of the planer coil antenna.

17. An antenna device comprising:
a spiral coil pattern having a first section formed on a first plane and a second section formed on a second plane crossing the first plane; and
a metal layer,
wherein the spiral coil pattern defines an inner diameter area having a first area on the first plane and a second area on the second plane, and
wherein metal layer covers at least a part of the first section of the spiral coil pattern and at least a part of the first area of the inner diameter area without covering at least a part of the second section of the spiral coil pattern and at least a part of the second area of the inner diameter area.

18. The antenna device as claimed in claim 17,
wherein the metal layer includes a first metal layer and a second metal layer,
wherein the first metal layer covers the part of the first section of the spiral coil pattern and the part of the first area of the inner diameter area, and
wherein the second metal layer covers a remaining part of the second section of the spiral coil pattern and a remaining part of the second area of the inner diameter area.

19. The antenna device as claimed in claim 18,
wherein the inner diameter area having a border line between the first area and the second area, and
wherein the border line is free from the metal layer.

20. The antenna device as claimed in claim 17, wherein the first area is greater than the second area.
